(19) United States
(12) Patent Application Publication
(10) Pub. No.: US 2011/0054756 A1
(43) Pub. Date: Mar. 3, 2011

(54) DRIVING ASSISTANCE SYSTEM FOR MOTOR VEHICLES, METHOD FOR THE HAPTIC WARNING OF A DRIVER OF A MOTOR VEHICLE, AND USE THEREOF

(76) Inventors: Falk Hecker, Markgroeningen (DE); Ulrich Guecker, Schwieberdingen (DE); Andreas Buch, Taufkirchen (DE)

(21) Appl. No.: 12/736,404

(22) PCT Filed: Apr. 8, 2009
(86) PCT No.: PCT/EP2009/002589

§ 371 Date: Nov. 15, 2010

(30) Foreign Application Priority Data
Apr. 11, 2008 (DE) 10 2008 018 474.8

(51) Int. Cl. B60T 7/12

(52) U.S. Cl. 701/70

(57) ABSTRACT

A driving assistance system for motor vehicles, having a hazard sensor, is described that uses the brake system of the motor vehicle for the haptic warning of a driver, in that selected brake actuators of the vehicle are activated and deactivated according to a predetermined pattern. In this manner, depending on the pattern, a vibration of a steering wheel of the vehicle may be generated, as well as a response of the vehicle which simulates driving on an uneven roadway or a “washboard” roadway, or driving over an obstacle. In addition, a haptically perceivable warning signal may also be provided for a given deflection direction of the steering wheel via the difference in braking force between left and the right front wheels.

### FIELD OF THE INVENTION

The present invention relates to a driving assistance system for motor vehicles, a method for the haptic warning of a driver of a motor vehicle, and the use thereof.

### BACKGROUND INFORMATION

Modern driving assistance systems for motor vehicles are intended to warn the driver of hazardous situations. One example thereof is a so-called lane departure warning system, which monitors via sensors, for example a camera, ultrasonic sensors, radar signals, or the like, whether there is a risk of the vehicle leaving the roadway, whereupon a warning signal is generated (see, for example, German patent documents DE 10 2006 032 554 A1 or DE 10 2006 050 214 A1).

Distance warning systems operate in a similar manner; such systems measure the distance of the vehicle from a preceding vehicle or an obstruction, and as a function of the vehicle speed and the distance ascertain whether there is a risk of collision.

Other systems monitor the attentiveness of the driver, using, a camera, by observing the driver's eye movements, blinking frequency, or the like, and likewise generate a warning when an attention deficit is determined.

In addition to acoustic and optical warnings, it is known that haptic warnings are also very effective. Such warnings are very quickly received, do not distract the driver, and intuitively and directly lead the driver to a correct response. Thus, the driver automatically associates vibration of the steering wheel, for example, with the steering operation, and his attention is guided directly to the roadway lane. In the above-mentioned lane departure warning system it is therefore also known to initiate vibration of the steering wheel when a lane sensor generates a warning signal.

However, setting the steering wheel into vibration requires appropriate control elements or actuators. In practice, this has been achieved heretofore using an electrically activatable power steering system, which in many compact and midsize passenger vehicles is available instead of a strictly hydraulic power steering system. However, such steering systems have not been available thus far in heavy-duty utility vehicles, since reasonable electrical generation of the necessary steering forces has not been possible heretofore.

### SUMMARY OF THE INVENTION

An object of the exemplary embodiments and/or exemplary methods of the present invention, therefore, is to improve a driving assistance system and a method for the haptic warning of a driver of a motor vehicle in such a way that an effective haptic warning may be generated with little complexity. This object is achieved by the features described herein as to the related system, the method, and the use thereof.

An aspect of the exemplary embodiments and/or exemplary methods of the present invention lies in using the reaction of the braking forces of the vehicle brake to generate a haptic warning signal.

Various interesting options are thus provided, namely,
as the result of alternating, momentary application of the left and right front wheel brakes, the steering wheel may be set into vibration by the reaction on the steering system;
as the result of simultaneous pulsed application of both brakes of the front axle or of all brakes of the vehicle, vibration of the entire vehicle may be induced, which the driver perceives as an uneven roadway, and his attention is directed to the roadway;
as the result of simultaneous, one-time application of the brakes of the front axle or of all brakes of the vehicle, a jerk of the vehicle may be produced, which simulates for the driver a pothole or driving over an obstruction;
these various options for applying the brakes may also be supeimposed, so that, for example, vibration of the steering wheel and vibration or jerking of the entire vehicle are produced at the same time;
as the result of braking the front wheels with a different intensity on one side of the vehicle compared to the other side of the vehicle, a yaw moment corresponding to the roll radius of the vehicle may be generated which haptically indicates to the driver the particular direction in which he is to steer.

As a result of the application frequency of the individual brakes and the braking force triggered in each case, different haptic patterns may be generated which are adapted to the particular hazardous situation, for example the situations of lane departure, imminent collision, excessive speed, fatigue or inattentiveness of the driver, etc.

Implementation in present utility vehicles is possible with little complexity, since most modern utility vehicles are already provided with an electronic braking system (EBS) or electronic stability program (ESP) which allows autonomous application of the individual brakes of the vehicle. Therefore, no additional actuators are necessary for generating the desired haptic warning.

Thus, in practice, with the assistance of the electronic braking system or the ESP, a slight brake pressure on the front axle may be requested which alternates on the left and right sides, and which at the appropriate frequency is perceivable as vibration on the steering wheel. The driver may thus be made aware of a departure from the roadway lane.

When a slight brake pressure is cyclically requested on the front axle with the assistance of the electronic braking system or the ESP, the driver perceives this similarly as he does a “washboard” roadway.

A single, brief braking jerk is perceived as driving over an obstruction. Both described types are suitable as a warning for an imminent collision.

When, with the assistance of the electronic braking system or the ESP, a slight brake pressure on the front axle is requested which is randomly distributed to the left and the right sides, this is perceived by the driver as a very uneven roadway.

The cyclical braking interventions may be superimposed as the result of a pressure differential between the left and right sides in order to achieve a given steering effect which is a function of the roll radius. The-driver may thus also be provided with a steering instruction concerning which direction he is to turn the steering wheel in order to make a lane correction which may be necessary.

In brief, the exemplary embodiments and/or exemplary methods of the present invention therefore provides for the use of a motor vehicle brake system for the haptic warning of a driver.

According to the method of the present invention this is achieved on the basis of a signal of a hazard sensor, in that the signal of the hazard sensor momentarily activates braking of a vehicle. This may be carried out multiple times in alternation on the front axle brakes of a left front wheel and a right front wheel, or at least on all front axle brakes simultaneously, in particular multiple times cyclically, multiple times randomly, or a single time.

All known sensors, for example cameras, distance measuring instruments based on ultrasound, radar, etc., may be used as hazard sensors.

The exemplary embodiments and/or exemplary methods of the present invention are explained below with reference to one exemplary embodiment in conjunction with the drawings.

### BRIEF DESCRIPTION OF THE DRAWINGS

FIG. 1 shows a schematic diagram of a motor vehicle having a driving assistance system according to the present invention.

FIG. 2 shows a time diagram of control pulses for the left and right front axle brakes for generating a vibration of the steering wheel.

FIG. 3 shows a time diagram of control pulses for the left and right front axle brakes for simulating a washboard roadway.

FIG. 4 shows a time diagram of control pulses for the left and right front axle brakes for simulating driving over an obstruction.

FIG. 5 shows a time diagram of control pulses for the left and right front axle brakes for generating a steering instruction and simultaneous vibration.

### DETAILED DESCRIPTION

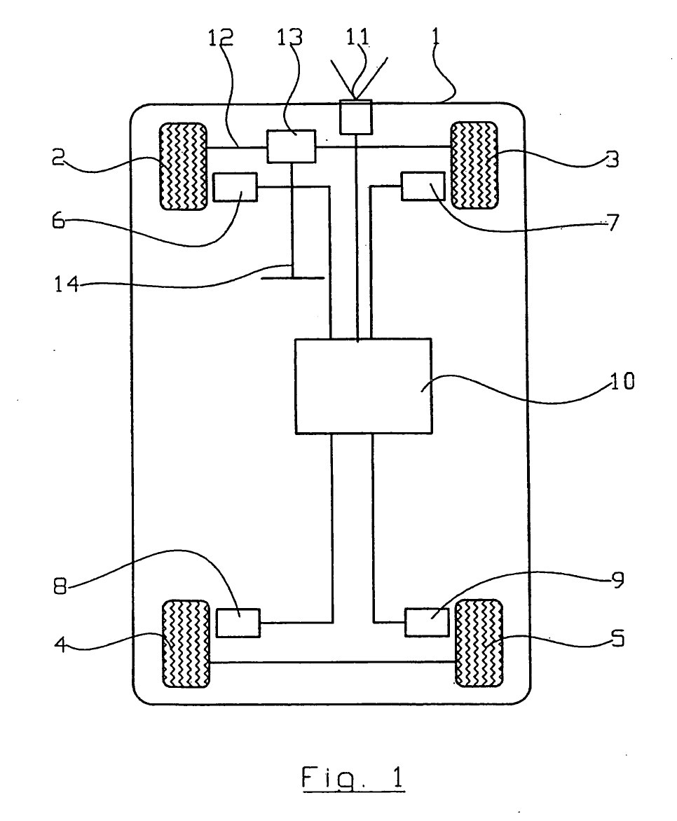

FIG. 1 schematically shows a motor vehicle 1 having a left front wheel 2, a right front wheel 3, a left rear wheel 4, and a right rear wheel 5. A brake actuator 6, 7, 8, 9, is respectively associated with each of the wheels, each brake actuator 6 through 9 being individually activatable by a central control unit 10.

The vehicle also has a hazard sensor 11 which, for example, is a lane sensor for scanning the roadway, or a distance sensor for measuring the distance from an obstruction or a preceding vehicle. Of course, multiple different sensors may be provided, all of which are connected to central control unit 10. The two front wheels 2 and 3 are connected in a known manner to a steering system 14 via a steering linkage 12 and optionally a steering gear 13.

The function of the haptic warning is carried out by the combination of hazard sensor 11 of central control unit 10 and brake actuators 6 and 7, and also optionally brake actuators 8 and 9, which have a haptically perceivable reaction on steering system 14 and/or entire vehicle 1.

The central control unit processes signals of hazard sensor 11, and triggers various haptically perceivable warnings by activating individual brake actuators 6, 7 and optionally 8, 9 according to a predetermined pattern.

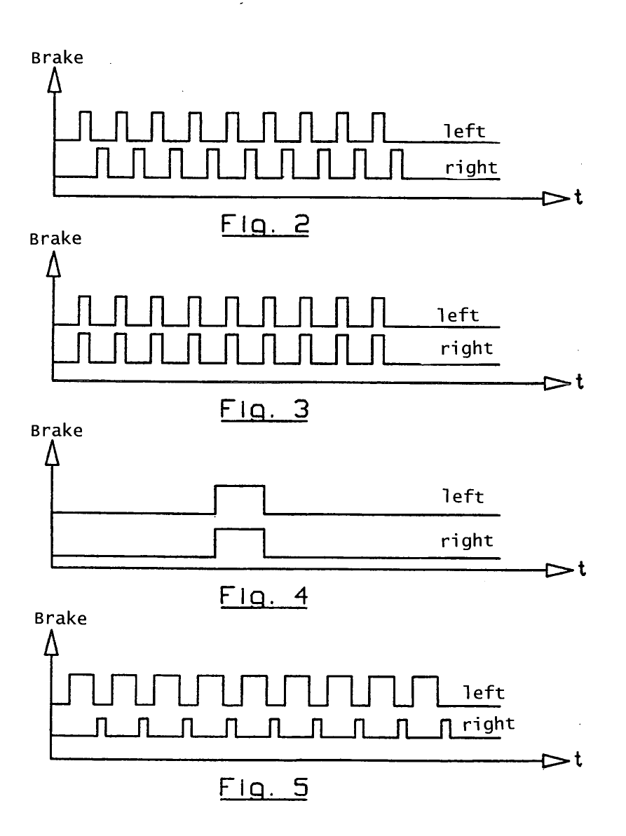

FIG. 2 illustrates the variation over time of control pulses for brake actuators 6 and 7 of the left front wheel and right front wheel, respectively. These brake actuators are activated in alternation, offset in time, using brief pulses in the range of 10 to 100 milliseconds, the duration of the pulses and the duration of the pauses being selected in such a way that vibration of the steering system or of the steering wheel occurs, but there is no significant braking effect for the overall vehicle.

In FIG. 2 a pulse signifies that during this period of time the particular brake actuator is activated in order to apply the brake, while during a pulse pause the brake actuator is deactivated and the brake is released. Depending on the type of application, such as by an electropneumatic or strictly electrical arrangement, for example, the pulses illustrated in FIG. 2 are then converted to braking commands, for electropneumatic application with pulse width modulation, for example, it being possible to vary the braking force which is ultimately requested.

The cyclically alternating activation of left and right brake actuators 6 and 7 on the front axle results in vibration of the steering system.

In FIG. 3 both brake actuators 6 and 7 on the front axle are cyclically activated at the same time. As a result there is a reaction not on steering system 14 of the vehicle, but, rather, on the entire vehicle, which the driver is made aware of as a simulation of a washboard roadway.

In FIG. 4 the two brake actuators 6 and 7 are activated only once, with a fairly intense simultaneous braking effect, thus generating a “brake pressure,” and thus for the driver, a haptic warning signal corresponding to driving over an obstruction.

In FIG. 5 the two brake actuators 6 and 7 on the front axle are activated in such a way that the braking effect is more intense on one side, for example on left front wheel 2, than on the right front wheel, resulting in a pressure differential which generates a yaw moment corresponding to the roll radius of the steering system, and thus generates a steering effect which haptically indicates to the driver in which direction he is to make a steering correction.

1-13. (canceled)

14. A driving assistance system for a motor vehicle having wheels, comprising:
a control unit; and
a hazard sensor which generates a hazard signal, wherein the hazard sensor is connected to the control unit which activates brake actuators of the wheels of the vehicle according to a predetermined pattern.

15. The driving assistance system of claim 14, wherein the control unit cyclically activates a brake actuator of a left front wheel and a brake actuator of a right front wheel in alternation.

16. The driving assistance system of claim 14, wherein the control unit cyclically activates at least all brake actuators of all front wheels.

17. The driving assistance system of claim 14, wherein the control unit activates at least all brake actuators of all front wheels a single time.

18. The driving assistance system of claim 14, wherein the control unit activates the brake actuators of the front wheels so that a more intense braking force is generated on one side of the vehicle than on another side of the vehicle.

19. A method for haptically warning a driver of a motor vehicle, the method comprising:
generating a hazard signal with a hazard sensor, wherein the hazard sensor is connected to the control unit;
using the control unit to activate brake actuators of the wheels of the vehicle according to a predetermined pattern.

20. The method of claim 19, wherein the signal of the hazard sensor activates and then deactivates brake actuators of at least the front wheels according to a predetermined pattern.

21. The method of claim 20, wherein the predetermined pattern cyclically activates and then deactivates the brake actuators of the left front wheel and of the right front wheel in alternation.

22. The method of claim 20, wherein the predetermined pattern cyclically activates at least all brake actuators of all front wheels at the same time.

23. The method of claim 20, wherein the predetermined pattern activates at least the brake actuators of all front wheels a single time.

24. The method of claim 20, wherein the predetermined pattern activates the brake actuators of one side of the front wheels according to a different pattern than those of another side.

25. The method of claim 20, wherein the predetermined pattern is a superimposition of a first pattern in which the signal of the hazard sensor activates and then deactivates brake actuators of at least the front wheels according to a predetermined pattern, and a second pattern in which the predetermined pattern cyclically activates at least all brake actuators of all front wheels at the same time.

26. The method of claim 20, wherein the predetermined pattern is a superimposition of a first pattern in which the predetermined pattern cyclically activates and then deactivates the brake actuators of the left front wheel and of the right front wheel in alternation, and a second pattern in which the predetermined pattern cyclically activates at least all brake actuators of all front wheels at the same time.

27. A method for haptically warning a driver of a motor vehicle, the method comprising:
generating a hazard signal with a hazard sensor, wherein the hazard sensor is connected to the control unit;
using the control unit to activate brake actuators of the wheels of the vehicle according to a predetermined pattern;
wherein the control unit and brake actuators are part of a brake system of the motor vehicle.
